(19) United States
(12) Patent Application Publication
(10) Pub. No.: US 2005/0251790 A1
(43) Pub. Date: Nov. 10, 2005

(54) Systems and methods for instrumenting loops of an executable program

(76) Inventor: Robert Hundt, Santa Clara, CA (US)

Correspondence Address: HEWLETT-PACKARD COMPANY;Intellectual Property Administration, P.O. BOX 272400, Fort Collins, CO, 80527-2400, US

(21) Appl. No.: 11/089,584

(22) Filed: Apr. 14, 2004

(51) Int. Cl. G06F 9/44

(52) U.S. Cl. 717/130

(57) ABSTRACT

Systems and methods for instrumenting a loop of an executable program are disclosed. One embodiment relates to a method of inserting instrumentation code into an executable program. The method may comprise inserting a register adder initialization instruction prior to a loop entry point of a loop in an executable program such that paths reaching the loop entry point also reaches the register adder initialization instruction, inserting a register add instruction between the loop entry point and prior to a back edge of the loop, and inserting a loop counter update instruction after the back edge of the loop.

### CROSS REFERENCE TO RELATED APPLICATIONS

This application is related to the following commonly assigned co-pending patent application entitled: “SYSTEMS AND METHODS FOR BRANCH PROFILING LOOPS OF AN EXECUTABLE PROGRAM,” Attorney Docket No. 200313027-1, which is filed contemporaneously herewith and is incorporated herein by reference.

### BACKGROUND

Code instrumentation is a method for analyzing and evaluating program code performance. Source instrumentation modifies a program's original source code, while binary instrumentation modifies an existing binary executable. In one approach to binary code instrumentation, new instructions or probe code are added to an executable program, and consequently, the original code in the program is changed and/or relocated. Some examples of probe code include adding values to a register, moving the address of some data to some registers, and adding counters to determine how many times a function is called. The changed and/or relocated code is referred to as instrumented code, or more generally, as an instrumented process.

One specific type of code instrumentation is referred to as dynamic binary instrumentation. Dynamic binary instrumentation allows program instructions to be changed on-the-fly. Measurements such as basic-block coverage and function invocation counting can be accurately determined using dynamic binary instrumentation. Additionally, dynamic binary instrumentation, in contrast to static instrumentation, is performed at run-time of a program and only instruments those parts of an executable that are actually executed. This minimizes the overhead imposed by the instrumentation process itself. Furthermore, performance analysis tools based on dynamic binary instrumentation require no special preparation of an executable such as, for example, a modified build or link process.

### SUMMARY

One embodiment of the present invention may comprise a system for instrumenting loops of an executable program. The system may comprise a dynamic instrumentation tool that inserts a register add instruction associated with a back edge of a loop in an executable program and a loop counter update instruction associated with an exit point of the loop. The register add instruction may increment a register value with executed iterations of the loop for a given loop execution, and the loop counter update instruction may update a loop counter value based on the register value at completion of the given loop execution. The system may have a shared memory that retains the loop counter value associated with a total number of loop iterations of the loop.

Another embodiment may comprise a method of inserting instrumentation code into a loop of an executable program. The method may comprise inserting a register adder initialization instruction prior to a loop entry point of a loop in an executable program such that paths reaching the loop entry point also reach the register adder initialization instruction, inserting a register add instruction between the loop entry point and prior to a back edge of the loop, and inserting a loop counter update instruction after the back edge of the loop.

Yet another embodiment of the present invention may relate to a computer readable medium having computer executable instruction for performing a method. The method may comprise performing loop analysis on an executable program to identify at least one loop, assigning a register add instruction to a back edge of the at least one loop, and assigning a loop counter update instruction to an exit point associated with the at least one loop.

Still another embodiment may relate to a dynamic instrumentation system. The dynamic instrumentation system may comprise means for generating an intermediate representation of a function associated with an executable program, means for analyzing the intermediate representation to identify at least one loop in the function, and means for inserting code into the identified at least one loop. The means for inserting code may insert a register add instruction between a loop entry point and a back edge of the identified at least one loop, and a loop counter update instruction after the back edge of the identified at least one loop. The dynamic instrumentation system may comprise means for encoding the inserted code and the intermediate representation of the function to produce an instrumented function.

### BRIEF DESCRIPTION OF THE DRAWINGS

FIG. 1 illustrates an embodiment of a dynamic instrumentation system.

FIG. 2 illustrates an embodiment of components associated with a dynamic instrumentation tool.

FIG. 3 illustrates an embodiment of a block diagram of contents of a portion of shared memory.

FIG. 4 illustrates an embodiment of a loop associated with an executable program having instrumentation counters inserted therein.

FIG. 5 illustrates a methodology for inserting instrumentation code into loops of an executable program.

FIG. 6 illustrates an embodiment of an alternate methodology for inserting instrumentation code into loops of an executable program.

FIG. 7 illustrates an embodiment of yet another alternate methodology for inserting instrumentation code into loops of an executable program.

FIG. 8 illustrates an embodiment of a computer system.

### DETAILED DESCRIPTION

This disclosure relates generally to dynamic instrumentation systems and methods. A loop analysis is performed on an executable program to identify loops associated with the executable program. A register add instruction is inserted at a back edge of a loop, and a loop counter update instruction is inserted at an exit point associated with the loop. A back edge of the loop is a branch from the bottom of the loop to an entry point of the loop that builds the loop cycle. A register add instruction increments a register value based on loop iterations associated with a loop execution. The loop counter update instruction updates a loop counter that maintains a count of loop iterations over a plurality of loop executions. The loop counter update instruction can include one or more instructions to update a loop counter (e.g., stored in memory). The number of instructions for updating the loop counter is based on the particular processor architecture being employed.

During program execution, the register add instruction increments a register value with executed iterations of an executed loop. The register counter instruction can employ a free register of the system (e.g., processor architecture). A free register is a register that can be safely modified without modifying the program semantics of the executable program. The employment of a free register provides for multi-thread safe operation of the instrumentation counter. Additionally, register add instructions are substantially faster and shorter (less code size) than instructions to increment a counter in memory. Thus, employing register add instructions instead of loop counter memory update instructions for counting loop iterations provides for improved execution speeds associated with an instrumented executable program.

The loop counter update instruction can be embedded in a multi-thread safe set of ownership instructions, such a spinlock operation. A spinlock operation provides a thread with ownership of the loop counter value stored in memory preventing other threads from incrementing the loop counter value, until the ownership is released.

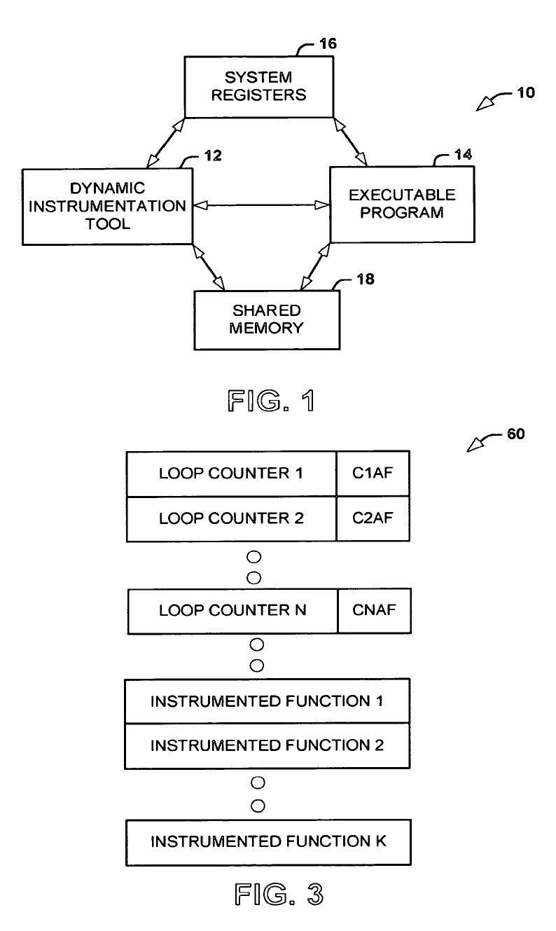

FIG. 1 illustrates a dynamic instrumentation system 10. The dynamic instrumentation system 10 can be a computer, a server or some other computer medium that can execute computer readable instructions. For example, the components of the system 10 can be computer executable components, such as can be stored in a desired storage medium (e.g., random access memory, a hard disk drive, CD ROM, and the like), computer executable components running on a computer. The dynamic instrumentation system 10 includes a dynamic instrumentation tool 12. The dynamic instrumentation tool 12 interfaces with an executable program or executable program 14 to assign instrumentation (e.g., counters) to the executable program 14.

The dynamic instrumentation tool 12 is operative to assign instrumentation counters and insert instrumentation counter instructions in at least one loop associated with the executable program 14. The instrumentation counters include a register adder that counts iterations associated with a loop execution, and a loop counter that maintains a count associated with total loop iterations over one or more loop executions. The dynamic instrumentation tool 12 is operative to assign a free register to the at least one loop. A free register can be found by analyzing the executable program 14 to determine which registers are not used by the executable program. Additionally, the code can be analyzed to determine which registers are currently available for use that would not interfere with the program execution. It is to be appreciated that a variety of techniques can be employed to find a free register.

The dynamic instrumentation tool 12 can load the executable program 14 and insert breaks at a beginning of each function under the control of a debugging interface, which is provided by the operating system (e.g., ttrace( ) on HP-UX® Operating System, ptrace( )on LINUX® Operating System, Extended Debugging Interface (eXDI) on MICROSOFT WINDOWS® Operating System). The executable program 14 then is executed. The debugging interface makes it possible to transfer control from the target application to the dynamic instrumentation tool 12 whenever a break is encountered in the executable program.

As the executable program 14 encounters the breaks corresponding to a new reached function, control is passed to the dynamic instrumentation tool 12. The dynamic instrumentation tool 12 loads the function. The dynamic instrumentation tool 12 then converts the function into an intermediate representation by decoding the binary code associated with the function and converting the decoded binary code via an intermediate representation instrument. A control flow graph constructor then generates a control flow graph from the intermediate representation. A loop analysis is then performed on the intermediate representation by a loop recognition algorithm. The dynamic instrumentation tool 12 can then insert one or more instrumentation counters via a probe code instrumenter.

The loop counter updates can be minimized by inserting register adders in the innermost loops of the executable program 14. The innermost loops of the executable program are loops that contain no inner loops, while the outermost loops are not nested in any outer loop. Intermediate loops are loops that are both inner loops and outer loops, such that the intermediate loop is a loop that is nested in one or more outer loops and also contain one or more inner loops nested therein. The execution speed of the intstrumented code can be improved by generating free registers for innermost loops first, intermediate loops second, and outermost loops last, as long as free registers are available. Typically, loop counters are employed to count loop iterations by utilizing atomic memory update instructions. The atomic memory update instructions are multi-thread safe, but are substantially time intensive (e.g., about 20 clock cycles) as compared to a register add instruction (e.g., about 1 clock cycle).

In one embodiment of the present invention, a register adder initialization instruction is inserted prior to an entry point of the loop in a way such that paths reaching the loop entry point also reach the register adder initialization instruction. A register add instruction is inserted prior to or at a back edge of the loop, or between the entry point and the back edge. The register add instruction employs the free register to increment a loop count value for iterations of a loop during a loop execution. The register add instruction is substantially faster than an atomic memory update instruction. A loop counter update instruction is then inserted prior to an exit point of the loop and after the back edge of the loop. The loop counter update instruction maintains a count associated with total loop iterations over one or more loop executions. The loop counter value is retained in a corresponding memory location associated with a respective loop. The loop counter update instruction can be embedded in a multi-thread safe set of ownership instructions, such as a spinlock operation.

The dynamic instrumentation tool 12 then encodes the modified function code to provide an instrumented function in binary form. The instrumented function is stored in a shared memory 18. The original entry point of the function (where the break point was placed) is patched with a branch/jump to the instrumented version of the function. Execution is then resumed at the address of the instrumented function (e.g., resume can be an option in the debug interface). Therefore, control has been transferred back to the executable program, which continues to execute until another breakpoint at a new non-encountered function is encountered. The process then repeats for the next function until all function have been instrumented. Once the executable program 14 and instrumented functions have completed execution, the dynamic instrumentation tool 12 can retrieve the loop counter values from the shared memory 18.

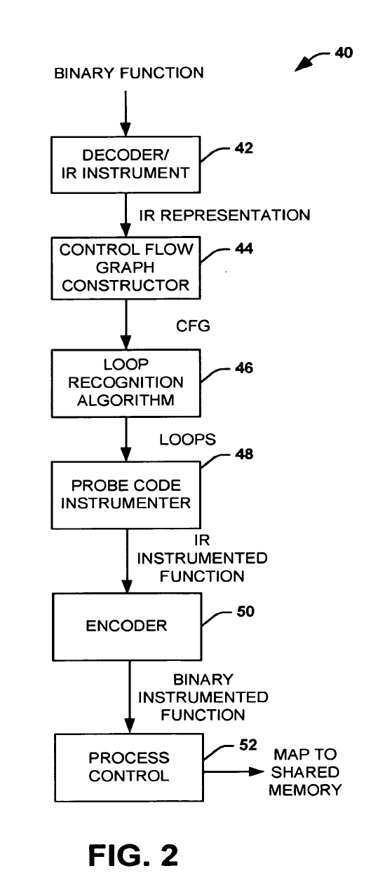

FIG. 2 illustrates components associated with a dynamic instrumentation tool 40. The dynamic instrumentation tool 40 includes a decoder and an intermediate representation (IR) instrument 42 that reads in the binary function, and decodes the binary function into an intermediate representation. A control flow graph constructor 44 can configure the intermediate representation as a control flow graph with basic blocks and edges between those blocks representing possible flows of control. A loop analysis can be performed on the loop by a loop recognition algorithm 46. The loop recognition algorithm 46 can be one of many different algorithms known for recognizing loops in a control flow graph.

The dynamic instrumentation tool 40 also includes a probe code instrumenter 48. The probe code instrumenter 48 can insert a register adder initialization instruction prior to an entry point of the loop in a way such that every path reaching the loop entry point also reaches the register adder initialization instruction, a register add instruction prior to or at a back edge of the loop, or between the entry point and the back edge, and a loop counter update instruction prior to an exit point of the loop and after the back edge of the loop. The probe code instrumenter 48 can generate free registers associated with the register add instructions for one or more innermost loops, as long as free registers are available. The dynamic instrumentation tool 40 includes an encoder 50 that encodes the IR instrumented function into a binary instrumented function. The dynamic instrumentation tool 40 includes a process control 52 that stores the binary instrumented function in shared memory, patches a branch/jump instruction in the executable program where the break point was placed, and passes control back to the executable program.

FIG. 3 illustrates a block diagram of contents of a portion of shared memory 60 associated with instrumenting loops of an executable program. The shared memory 60 retains loop counter values for loops, labeled 1 to N, in the executable program, where N is an integer greater than or equal to one. The loop counter values can correspond to the number of executed iterations of innermost loops, outermost loops and/or intermediary loops that have executed in the executable program. Additionally, the loop counter values can correspond to a single function, or a plurality of functions associated with the executable program. The loop counter values are updated each time a loop completes execution in the executable program and a loop exit point is encountered. The loop counter values are updated by adding the value of the register adder that corresponds to the number of loop iterations associated with a loop execution. Since the loop counter values reside in shared memory 60, the loop counter values are not multi-thread safe.

Therefore, the shared memory 60 includes counter access flags, labeled C1AF through CNAF, associated with each loop counter value. The counter access flags are employed to maintain ownership of the loop counter value memory spaces by a single process at a time, so that loop counter value integrity is maintained. For example, if a process desires to overwrite a corresponding loop counter value, the process will request control of the loop counter value by checking the corresponding counter access flag. If the counter access flag is not set, the process will set the flag and update the corresponding loop counter value. The process will then reset the flag and release control of the loop counter value, so that other processes may access the loop counter value in shared memory 60. In this manner, the loop counter values maintain loop counter value integrity by being multi-thread safe.

The shared memory 60 also retains a plurality of instrumented functions, labeled 1 through K, where K is an integer greater than or equal to one. The dynamic instrumentation tool stores the encoded instrumented functions in shared memory 60 to provide ready access to both the instrumentation tool and the executable program. A branch/jump instruction is employed as a patch at the start of a non-instrumented function, so whenever the original entry point of the non-instrumented function is reached, execution resumes/continues at the instrumented version of the function. Once the executable program is instrumented, a substantial portion of executable program execution occurs in shared memory 60 via the instrumented functions corresponding to the non-instrumented functions that have been reached.

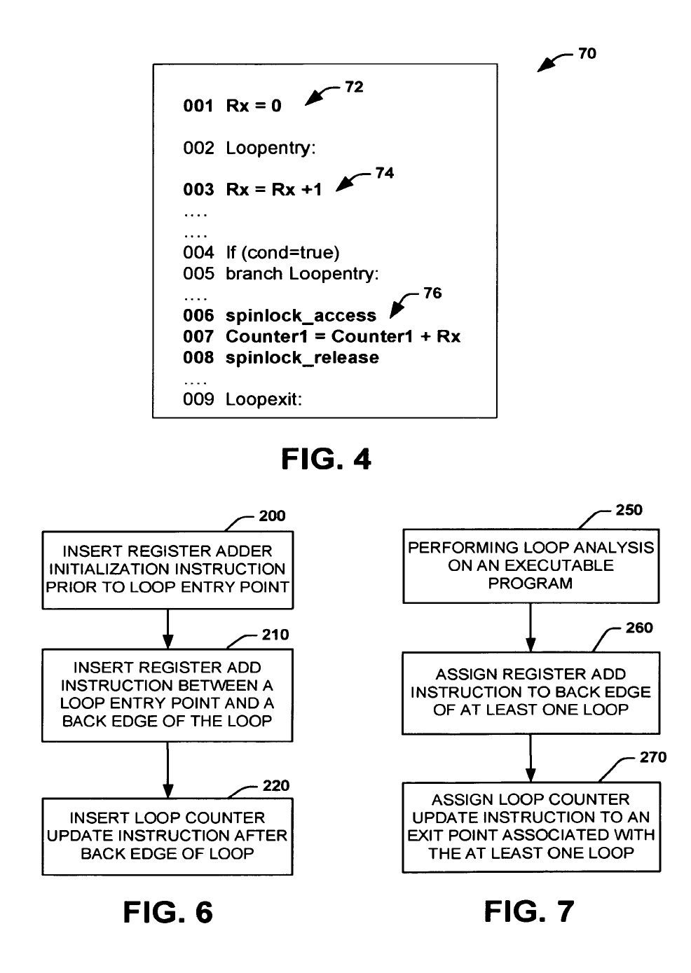

FIG. 4 illustrates a loop 70 associated with an executable program having instrumentation counters inserted therein. The loop 70 can reside in a function in the executable program. The loop 70 can be an innermost loop, an outermost loop or an intermediary loop. The loop 70 includes instrumentation code provided by a dynamic instrumentation tool. The dynamic instrumentation tool assigns a free register to the loop 70 and inserts a register adder initialization instruction 72 (Rx=0) at line 001 prior to a loop entry point at line 002, such that paths reaching the loop entry point also reach the register adder initialization instruction 72. The dynamic instrumentation tool also inserts a register add instruction 74 (Rx=Rx+1) at line 003 between the loop entry point and a back edge of the loop 70 at lines 004 and 005. The register add instruction 74 causes the value of a free register to be incremented (e.g., by one) each loop iteration associated with a loop execution.

The dynamic instrumentation tool also inserts a loop counter update instruction 76 (Counter1=Counter1+Rx) at line 007 after the back edge of the loop and prior to an exit point of the loop 70 at 009. Execution of the loop counter update instruction 76 causes a loop counter value in shared memory to be updated by adding the value of the register adder (Rx) to the loop counter value in shared memory.

In certain circumstances, the number of iterations is fixed. For example, when a programmer employs numerical integer constants to denote the loop start, end and increment values. This can be found by the loop recognition algorithm, and an exact trip count can be derived. If the loop contains no other exits, we know that the loop will execute “trip-count” times. In this situation, a register add instruction is not necessary and the loop counter update instruction simply increments the loop counter value by a fixed number of loops (e.g., 10).

The loop counter update instruction 76 is embedded in memory ownership instructions, such that ownership of the loop counter value memory location is requested prior to updating of the loop counter value memory. For example, a spinlock command is a set of instructions that requests access of a loop counter value by checking the state of a loop access flag via a set of spinlock access instructions illustrated at line 006. The loop counter value (Counter1) is then updated by execution of the loop counter update instruction 76. The loop access flag is then reset via a set of spinlock release instructions illustrated at line 008, thus releasing ownership control of the memory location associated with the loop counter value. Although a single instruction is shown for illustrating a spinlock access instruction set, a loop counter update instruction and a spinlock release instruction set, a plurality of instructions can be employed to execute any of a spinlock access, a loop counter update and a spinlock reset.

The dynamic instrumentation tool can assign a free register, insert the register adder initialization instruction, the register add instruction and the loop counter update instruction in one or more loops. In one embodiment, the dynamic instrumentation tool assigns a free register, inserts the register adder initialization instruction, the register add instruction and the loop counter update instruction set for a plurality of innermost loops firstly, intermediate loops secondly, and outermost loops lastly, as long as free registers are available.

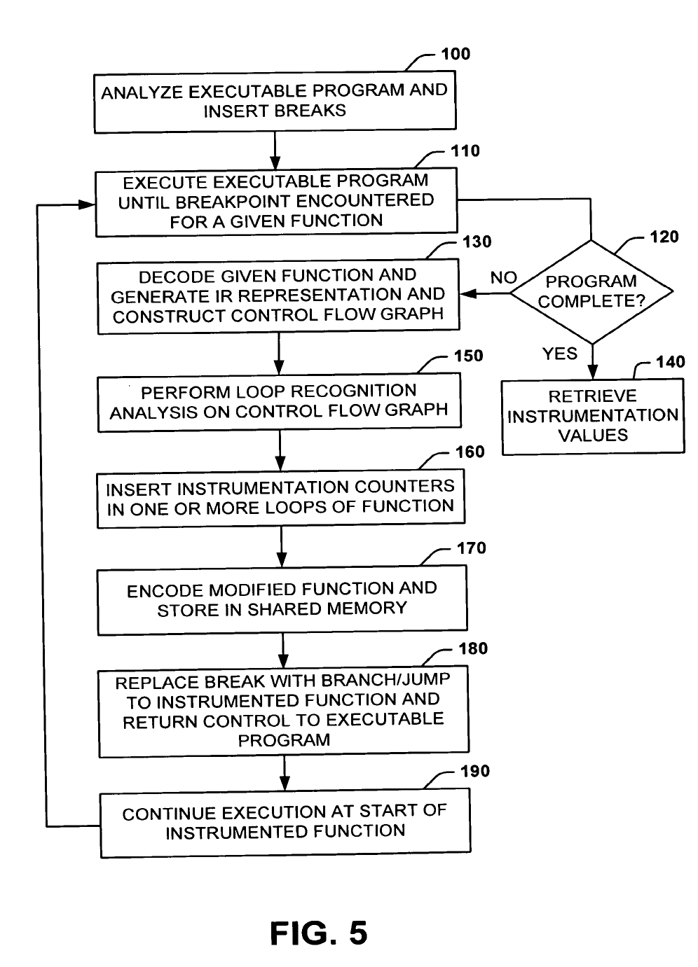

In view of the foregoing structural and functional features described above, certain methods will be better appreciated with reference to FIGS. 5-7. It is to be understood and appreciated that the illustrated actions, in other embodiments, may occur in different orders and/or concurrently with other actions. Moreover, not all illustrated features may be required to implement a method. It is to be further understood that the following methodologies can be implemented in hardware (e.g., a computer or a computer network as one or more integrated circuits or circuit boards containing one or more microprocessors), software (e.g., as executable instructions running on one or more processors of a computer system), or any combination thereof.

FIG. 5 illustrates a methodology for inserting instrumentation code into loops of an executable program. The methodology begins at 100 where an executable program is analyzed and breaks are inserted before each function. The executable program then begins execution, until a breakpoint is encountered for a given function. Once a breakpoint is encountered, the methodology proceeds to 120. At 120, a determination is made as to whether the executable program has completed execution. If the executable program has completed execution (YES), the methodology proceeds to 140 to retrieve the instrumentation values. If the executable program has not completed execution (NO), the methodology proceeds to 130.

At 130, the dynamic instrumentation tool decodes the executable function and generates an intermediate representation of the given function, and generates a control flow graph from the intermediate representation. The dynamic instrumentation tool then performs loop recognition analysis on the control flow graph to identify loops in the given function at 150. After the loops have been identified, the methodology proceeds to 160.

At 160, one or more instrumentation counters are inserted into one or more loops associated with the given function. A register adder initialization instruction is inserted prior to an entry point of a loop in a way such that every path reaching the loop entry point also reaches the register adder initialization instruction. A register add instruction is inserted prior to or at a back edge of the loop, or between the entry point and the back edge. The register add instruction employs a free register to increment a loop count value for iterations of a loop during a loop execution. A loop counter update instruction is then inserted prior to an exit point of the loop and after the back edge of the loop. The loop counter update instruction maintains a count associated with total loop iterations over one or more loop executions. The loop counter value is retained in a corresponding memory location associated with a respective loop. The loop counter update instruction can be embedded in a multi-thread safe set of ownership instructions, such a spinlock operation.

At 170, the modified instrumented executable function is encoded into a binary executable, and stored in shared memory. At 180, the break in the executable program associated with the given function is replaced with a branch/jump to the instrumented function and control is returned to the executable program. The methodology then proceeds to 190 where execution is continued at the start of the instrumented function. The methodology then returns to 110 until the next breakpoint is encountered.

FIG. 6 illustrates an alternate methodology for inserting instrumentation code in an executable program. At 200, a register adder initialization instruction is inserted prior to a loop entry point in the executable program in a way such that every path reaching the loop entry point also reaches the register adder initialization instruction. At 210, a register add instruction is inserted between the loop entry point and a back edge of the loop. At 220, a loop counter update instruction is inserted after the back edge of the loop.

FIG. 7 illustrates yet another alternate methodology for inserting instrumentation code in an executable program. At 250, loop analysis is performed on an executable program to identify at least one loop. At 260, a register add instruction is assigned to a back edge of the at least one loop. At 270, a loop counter update instruction is assigned to an exit point associated with the at least one loop.

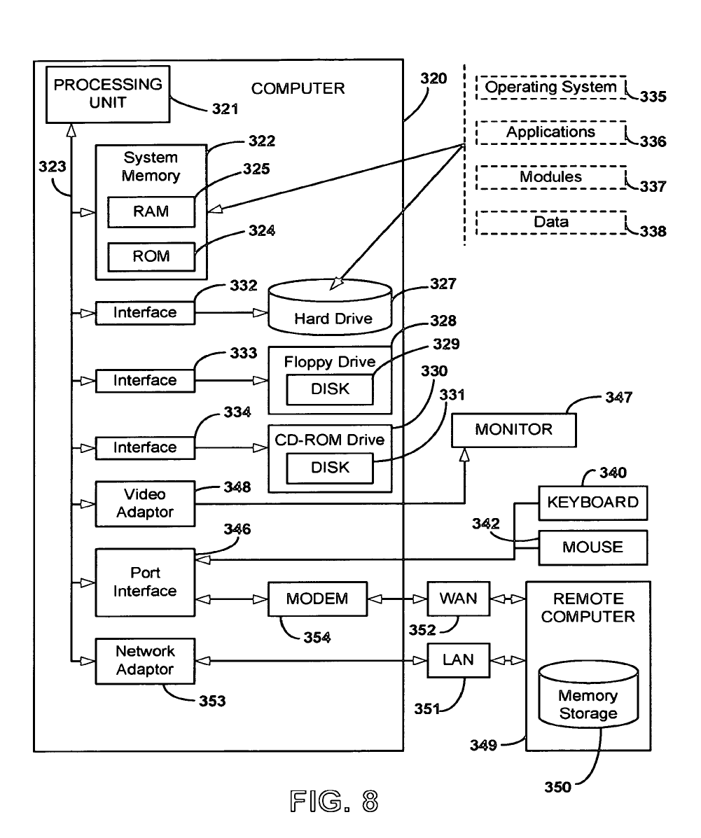

FIG. 8 illustrates a computer system 320 that can be employed to execute one or more embodiments employing computer executable instructions. The computer system 320 can be implemented on one or more general purpose networked computer systems, embedded computer systems, routers, switches, server devices, client devices, various intermediate devices/nodes and/or stand alone computer systems.

The computer system 320 includes a processing unit 321, a system memory 322, and a system bus 323 that couples various system components including the system memory to the processing unit 321. Dual microprocessors and other multi-processor architectures also can be used as the processing unit 321. The system bus may be any of several types of bus structure including a memory bus or memory controller, a peripheral bus, and a local bus using any of a variety of bus architectures. The system memory includes read only memory (ROM) 324 and random access memory (RAM) 325. A basic input/output system (BIOS) can reside in memory containing the basic routines that help to transfer information between elements within the computer system 320.

The computer system 320 can includes a hard disk drive 327, a magnetic disk drive 328, e.g., to read from or write to a removable disk 329, and an optical disk drive 330, e.g., for reading a CD-ROM disk 331 or to read from or write to other optical media. The hard disk drive 327, magnetic disk drive 328, and optical disk drive 330 are connected to the system bus 323 by a hard disk drive interface 332, a magnetic disk drive interface 333, and an optical drive interface 334, respectively. The drives and their associated computer-readable media provide nonvolatile storage of data, data structures, and computer-executable instructions for the computer system 320. Although the description of computer-readable media above refers to a hard disk, a removable magnetic disk and a CD, other types of media which are readable by a computer, such as magnetic cassettes, flash memory cards, digital video disks and the like, may also be used in the operating environment, and further that any such media may contain computer-executable instructions.

A number of program modules may be stored in the drives and RAM 325, including an operating system 335, one or more executable programs 336, other program modules 337, and program data 338. A user may enter commands and information into the computer system 320 through a keyboard 340 and a pointing device, such as a mouse 342. Other input devices (not shown) may include a microphone, a joystick, a game pad, a scanner, or the like. These and other input devices are often connected to the processing unit 321 through a corresponding port interface 346 that is coupled to the system bus, but may be connected by other interfaces, such as a parallel port, a serial port or a universal serial bus (USB). A monitor 347 or other type of display device is also connected to the system bus 323 via an interface, such as a video adapter 348.

The computer system 320 may operate in a networked environment using logical connections to one or more remote computers, such as a remote client computer 349. The remote computer 349 may be a workstation, a computer system, a router, a peer device or other common network node, and typically includes many or all of the elements described relative to the computer system 320. The logical connections can include a local area network (LAN) 351 and a wide area network (WAN) 352.

When used in a LAN networking environment, the computer system 320 can be connected to the local network 351 through a network interface or adapter 353. When used in a WAN networking environment, the computer system 320 can include a modem 354, or can be connected to a communications server on the LAN. The modem 354, which may be internal or external, is connected to the system bus 323 via the port interface 346. In a networked environment, program modules depicted relative to the computer system 320, or portions thereof, may be stored in the remote memory storage device 350.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

1. A system for instrumenting a loop of an executable program, the system comprising:
a dynamic instrumentation tool that inserts a register add instruction associated with a back edge of the loop in an executable program and a loop counter update instruction associated with an exit point of the loop, the register add instruction increments a register value with executed iterations of the loop for a given loop execution, and the loop counter update instruction updates a loop counter value based on the register value at completion of the given loop execution; and
a shared memory that retains the loop counter value associated with a total number of loop iterations of the loop.

2. The system of claim 1, wherein the loop counter update instruction is embedded in a set of loop counter value ownership instructions that facilitate multi-threaded safe loop counter value integrity.

3. The system of claim 2, wherein the shared memory retains a loop counter access flag associated with the loop, the set of loop counter value ownership instructions comprising at least a first instruction for requesting access to the loop counter value and setting the loop counter access flag prior to updating the loop counter value, and at least a second instruction for resetting the loop counter access flag after updating the loop counter value wherein access of the loop counter value is controlled based on the state of the loop counter access flag.

4. The system of claim 1, wherein the register value is retained in a free register of the system.

5. The system of claim 1, wherein the dynamic instrumentation tool dynamically assigns a respective free register, inserts a register add instruction associated with a back edge and a loop counter update instruction associated with an exit point of an innermost loop for each of a plurality of innermost loops.

6. The system of claim 1, wherein the loop is at least one of an innermost loop, an intermediary loop and an outermost loop of the executable program.

7. The system of claim 1, wherein the dynamic instrumentation tool decodes a given function of the executable program into an intermediate representation, constructs a control flow graph and performs a loop recognition to identify loops in the given function.

8. The system of claim 7, wherein the dynamic instrumentation tool encodes the given function with the inserted register add instruction and the loop counter update instruction to provide an instrumented function.

9. The system of claim 8, wherein the dynamic instrumentation tool stores the instrumented function in shared memory and inserts a branch/jump to the instrumented function at the given function in the executable program.

10. The system of claim 1, wherein the dynamic instrumentation tool inserts a register adder initialization instruction prior to a loop entry point such that paths reaching the loop entry point also reaches the register adder initialization instruction.

11. A method of inserting instrumentation code into a loop of an executable program, the method comprising:
inserting a register adder initialization instruction prior to a loop entry point of the loop such that paths reaching the loop entry point also reach the register adder initialization instruction;
inserting a register add instruction between the loop entry point and a back edge of the loop; and
inserting a loop counter update instruction after the back edge of the loop.

12. The method of claim 11, further comprising finding a free register to assign to the loop, the free register being initialized by the register adder initialization instruction and incremented by the register add instruction for each loop iteration associated with a loop execution of the loop.

13. The method of claim 11, further comprising repeating the inserting a register adder initialization instruction, inserting a register add instruction and inserting a loop counter update instruction for a plurality of innermost loops in a function of the executable program.

14. The method of claim 11, further comprising inserting the loop counter update instruction between a loop counter value ownership request instruction and a loop counter value ownership release instruction, wherein a loop counter value access flag is set when ownership of the loop counter value is provided and reset when ownership of the loop counter value is released.

15. The method of claim 11, wherein the inserting a register adder initialization instruction, inserting a register add instruction and inserting a loop counter update instruction for the loop is performed dynamically for a given function of the executable program as functions are executed.

16. A computer readable medium having computer executable instruction for performing a method comprising:
performing loop analysis on an executable program to identify at least one loop;
assigning a register add instruction to a back edge of the at least one loop; and
assigning a loop counter update instruction to an exit point associated with the at least one loop.

17. The computer readable medium having computer executable instruction for performing the method claim 16, wherein the performing a loop analysis on an executable program comprises:
representing a function of the executable program as an intermediate representation;
constructing a control flow graph from the intermediate representation; and
performing a loop recognition algorithm on the control flow graph to identify at least one loop in the function.

18. The computer readable medium having computer executable instruction for performing the method claim 16, wherein the assigning a register add instruction comprises inserting a register add instruction between a loop entry point of the at least one loop and a back edge of the at least one loop, and assigning a loop counter update instruction comprises inserting a loop counter update instruction after the back edge the at least one loop and prior to an exit point of the at least one loop.

19. The computer readable medium having computer executable instruction for performing the method claim 18, further comprising inserting a register adder initialization instruction prior to the loop entry point of the at least one loop, such that paths reaching the loop entry point also reaches the register adder initialization instruction.

20. The computer readable medium having computer executable instruction for performing the method claim 19, further comprising encoding the inserted instructions along with the at least one loop for an associated function to generate an instrumented function, and storing the instrumented function in memory.

21. The computer readable medium having computer executable instruction for performing the method claim 16, wherein the performing a loop analysis is performed dynamically on each function in the executable program as the executable program executes, such that the assigning a register add instruction to a back edge of the at least one loop, and assigning a loop counter update instruction to an exit point associated with the at least one loop is repeated for each function that includes at least one loop.

22. A dynamic instrumentation system comprising:
means for generating an intermediate representation of a function associated with an executable program;
means for analyzing the intermediate representation to identify at least one loop in the function;
means for inserting code into the identified at least one loop, the means for inserting code inserting a register add instruction between a loop entry point and a back edge of the identified at least one loop, and a loop counter update instruction after the back edge of the identified at least one loop; and
means for encoding the inserted code and the intermediate representation of the function to produce an instrumented function.

23. The system of claim 22, wherein the means for inserting code into the identified at least one loop comprising inserting a register adder initialization instruction prior to a loop entry point of the identified at least one loop, such that paths reaching the loop entry point also reaches the register adder initialization instruction.

24. The system of claim 22, further comprising means for storing a loop counter value associated with execution of the loop counter update instruction.

25. The system of claim 22, wherein the means for inserting code into the identified at least one loop comprising embedding the loop counter update instruction between loop counter value ownership instructions that facilitate multi-threaded safe loop counter value integrity.
